(19) United States
(12) Patent Application Publication
(10) Pub. No.: US 2014/0357825 A1
(43) Pub. Date: Dec. 4, 2014

(54) HIGH PRESSURE COMPRESSOR LUBRICATION

(71) Applicants: SHELL INTERNATIONALE RESEARCH MAATSCHAPP B.V., THE HAGUE (NL); Shell Oil Company, Houston, TX (US)

(72) Inventors: Klaus Volker, Hamburg (DE); Bernd Paul Lohmeyer, Hamburg (DE)

(21) Appl. No.: 14/366,507

(22) PCT Filed: Dec. 21, 2012
(86) PCT No.: PCT/EP2012/076816

§ 371 Date: Jun. 18, 2014

(30) Foreign Application Priority Data
Dec. 22, 2011 (EP) 11195305.5

(51) Int. Cl. C10M 169/02; C08F 2/01; F04D 29/06

(52) U.S. Cl. CPC C10M 169/02; F04D 29/06; C08F 2/01; C10M 107/00
USPC 526/348; 508/591

(57) ABSTRACT

A lubricant composition for lubricating a high pressure compressor, the composition comprising a Fischer-Tropsch derived base oil and a polymeric thickener. Use in high pressure compressors, especially hyper compressors is described, as are high pressure olefin methods.

### FIELD OF THE INVENTION

This invention relates to lubricants for high pressure compressors, especially hyper compressors. In particular, though not exclusively, the invention relates to lubricants for high pressure compressors comprising a polymeric thickener.

### BACKGROUND OF THE INVENTION

In the manufacture of high pressure polyolefins, for example high pressure low density polyethylene (HP-LDPE) or ethylene vinyl acetate (EVA), high operating pressures of 70 to 350 megapascals (MPa, or about 10,000 to 50,000 psi) are typical with operating pressures of 240 to 310 MPa (about 35,000 to 45,000 psi) preferred. To achieve these high pressures, one or more high pressure compressors, including a hyper compressor (or secondary compressor) are employed.

To manufacture high pressure polyolefins, olefinic raw material (e.g. ethylene) is typically first compressed to a pressure of up to about 25 to 30 MPa by one or more primary high pressure compressors.

Thereafter, one or more hyper compressors are employed to achieve the high operating pressures typically required, whereupon the olefinic raw material is converted into a polyolefin (e.g. HP-LPDE) in a reactor in the presence of a catalyst. Remaining unpolymerised raw material may be recycled for renewed compression.

Whilst the manufacture of high pressure polyolefins is of particular relevance to the invention, the term “high pressure compressor” is used herein to refer to any compressor capable of compressing a raw material, preferably ethylene, to a pressure of at least 20 MPa, preferably at least 30 MPa. The term “hyper compressor” is used herein to refer to any compressor capable of compressing a raw material, preferably ethylene, to a pressure of at least 50 MPa, preferably at least 100 MPa, as either a primary or, preferably, a secondary compressor.

Operating pressures typical in the manufacture of high pressure polyolefins, especially HP-LDPE, are amongst the highest, if not the highest, in any industrial process. High pressure compressors, and hyper compressors in particular, are hence based on a special architecture. They typically comprise moving parts of extremely hard material, such as tungsten carbide.

The operation of high pressure compressors, including hyper compressors, requires the use of lubricants to reduce friction between moving parts, such as between plungers/pistons and cylinders. Given the high operating pressures and the architecture of high pressure compressors, especially hyper compressors, lubricants for hyper compressors, especially hyper compressors, are subject to special requirements. One of the most difficult challenges for an equipment lubricant is presented by hyper compressors of the type commonly used to manufacture high pressure polyolefins, especially polyethylene.

For example, it is known that lubricant employed in hyper compressors unavoidably leaks downstream into the polymerisation reactor to mix with and become part of the reaction mass, e.g., ethylene, comonomer, solvent, catalyst, etc. This can in turn interfere with the formation of high pressure polyolefin or lead to a deterioration in polyolefin properties; there is hence a desire for lubricants with a low contamination impact.

Traditionally, mineral oil has been used as a high pressure and hyper compressor lubricant, and its leakage into the reaction mass has little, if any, adverse affect on either the formation of the high pressure polyolefin or the use of the polyolefin in subsequent fabrication, e.g., moulding or extrusion, process. However, mineral oil alone is not an effective high pressure compressor lubricant, degrading rapidly in performance, typically due to the dissolution of compressed raw material therein. Such dissolution is a particular challenge faced in formulating high pressure, especially hyper compressor lubricants, along with the need to ensure that lubricants remain pumpable (i.e. of a suitable viscosity).

One prior art approach has been to employ polyglycols, which have a low solubility e.g. in ethylene, as lubricants in hyper compressors. WO2009012041 describes a hyper compressor lubricant comprising a polyether polyol comprising no more than one hydroxyl functionality.

Another prior art approach has been to add thickeners, such as polybutene to mineral oil hyper compressor lubricants, as disclosed for example in U.S. Pat. No. 5,578,557.

It is an object of the invention to provide a lubricant composition for high pressure compressors, especially hyper compressors, with improved resistance to dissolution, especially olefin dissolution, and good viscosity/pumpability.

### SUMMARY OF THE INVENTION

From a first aspect, the invention resides in a lubricant composition for lubricating a high pressure compressor, the composition comprising a Fischer-Tropsch derived base oil and a polymeric thickener.

It has surprisingly been found that Fischer-Tropsch derived base oil is less susceptible to thickening with a polymeric thickener, such as polybutene, than is mineral base oil. Whilst in most lubricant applications this may represent a disadvantage of Fischer-Tropsch derived base oil, the reduced thickening has been applied by the inventors to achieve significant advantages in the context of lubricating high pressure compressors, especially hyper compressors. The inventors have found that it is possible to incorporate a greater proportion by weight of polymeric thickener into Fischer-Tropsch derived base oil than into mineral base oil at a given viscosity, such as a targeted pumping viscosity. In the specific field of high pressure compressors, the presence of a higher proportion of polymeric thickener is of advantage, helping to enhance resistance to dissolution at high pressure of compressed raw materials such as ethylene, minimize the decrease in viscosity and hence helping to counteract lubricant deterioration. This is achieved without the trade-off of increased viscosity: the Fischer-Tropsch based lubricant composition of the invention has been found to display reduced viscosity compared to a comparable mineral oil composition at a given proportion by weight of incorporated polymeric thickener (see Examples). In other words, less Fischer-Tropsch base oil may be needed to bring an given amount of polymeric thickener into the hypercompressor, without changing the other properties of the lubricant, such as kinematic viscosities at 40 and 100° C.

The invention embraces, according to a second aspect, to the use of a lubricant composition comprising a Fischer-Tropsch derived base oil and a polymeric thickener for lubricating a high pressure compressor. For example, according to a third aspect, the invention embraces a method of lubricating a high pressure compressor, the method comprising applying a lubricant composition comprising a Fischer-Tropsch derived base oil and a polymeric thickener to one or more friction interfaces of the high pressure compressor. According to a fourth aspect, the invention also embraces a high pressure compressor lubrication set, the set including: a lubricant composition comprising a Fischer-Tropsch derived base oil and a polymeric thickener; and instructions to apply the lubricant composition to a high pressure compressor.

From a fifth aspect, the invention resides in a method of pressurising an olefin, the method comprising: introducing the olefin into a high pressure compressor that is lubricated by a lubricant composition comprising a Fischer-Tropsch derived base oil and a polymeric thickener; and pressurising the olefin with the high pressure compressor.

From a sixth aspect, the invention resides in a method of making a high pressure polyolefin, the method comprising: pressurising an olefin with a high pressure compressor that is lubricated by a lubricant composition comprising a Fischer-Tropsch derived base oil and a polymeric thickener; and reacting the pressurised olefin to form the high pressure polyolefin.

From a seventh aspect, the invention resides in the use of a Fischer-Tropsch derived oil as a base oil in a high pressure compressor lubricant composition that includes a polymeric thickener. For example, according to an eighth aspect, the invention embraces a method of making a high pressure compressor lubricant composition, the method comprising mixing a Fischer-Tropsch derived base oil with a polymeric thickener.

From an ninth aspect, the invention resides in the use of a Fischer-Tropsch derived oil as a base oil in a lubricant composition that includes a polymeric thickener, for the purpose of achieving a higher thickener content by % weight in the composition than would be achieved by comparable use of a comparable mineral oil.

From a tenth aspect, the invention resides in the use of a Fischer-Tropsch derived oil as a base oil in a lubricant composition that includes a polymeric thickener, for the purpose of achieving a lower viscosity in the composition than would be achieved by comparable use of a comparable mineral oil.

Preferred features and embodiments of the invention, which may be combined with each other and all aspects of the invention as context permits, are set out in the following detailed description.

### DETAILED DESCRIPTION OF THE INVENTION

A first essential component in the lubricant composition herein is a Fischer-Tropsch derived base oil.

The term “Fischer-Tropsch derived” as used herein means that a material is, or derives from, a synthesis product of a Fischer-Tropsch condensation process. A Fischer-Tropsch derived base oil may also be referred to as a “GTL (Gas-to-Liquid)” base oil.

The Fischer-Tropsch condensation process is a reaction which converts carbon monoxide and hydrogen into longer chain, usually paraffinic, hydrocarbons; n(CO+2H₂)=(—CH₂—) n+nH₂O+ heat, in the presence of an appropriate catalyst and typically at elevated temperatures (e.g. 125 to 300° C., preferably 175 to 250° C.) and/or pressures (e.g. 5 to 100 bar, preferably 12 to 50 bar). Hydrogen:carbon monoxide ratios other than 2:1 may be employed if desired.

The carbon monoxide and hydrogen may themselves be derived from organic or inorganic, natural or synthetic sources, typically either from natural gas or from organically derived methane. In general the gases which are converted into liquid fuel components using Fischer-Tropsch processes can include natural gas (methane), LPG (e.g. propane or butane), “condensates” such as ethane, synthesis gas (CO/hydrogen) and gaseous products derived from coal, biomass and other hydrocarbons.

The Fischer-Tropsch process can be used to prepare a range of hydrocarbon fuels, including LPG, naphtha, kerosene and gas oil fractions. Of these, the gas oils have been used as, and in, automotive diesel fuel compositions, typically in blends with petroleum derived gas oils. The heavier fractions can yield, typically following hydroprocessing and vacuum distillation, a series of base oils having different distillation properties and viscosities, which are useful as lubricating base oil stocks.

Hydrocarbon products may be obtained directly from the Fischer-Tropsch reaction, or indirectly for instance by fractionation of Fischer-Tropsch synthesis products or from hydrotreated Fischer-Tropsch synthesis products. Hydrotreatment can involve hydrocracking to adjust the boiling range and/or hydroisomerisation which can improve cold flow properties by increasing the proportion of branched paraffins. Other post-synthesis treatments, such as polymerisation, alkylation, distillation, cracking-decarboxylation, isomerisation and hydroreforming, may be employed to modify the properties of Fischer-Tropsch condensation products.

Typical catalysts for the Fischer-Tropsch synthesis of paraffinic hydrocarbons comprise, as the catalytically active component, a metal from Group VIII of the periodic table, in particular ruthenium, iron, cobalt or nickel. Suitable such catalysts are described for instance in EP-A-0583836 (pages 3 and 4).

An example of a Fischer-Tropsch based process is the SMDS (Shell Middle Distillate Synthesis) described in “The Shell Middle Distillate Synthesis Process”, van der Burgt at al, paper delivered at the 5th Synfuels Worldwide Symposium, Washington D.C., November 1985; see also the November 1989 publication of the same title from Shell International Petroleum Company Ltd, London, UK. This process (also sometimes referred to as the Shell “Gas-To-Liquids” or “GTL” technology) produces middle distillate range products by conversion of a natural gas (primarily methane) derived synthesis gas into a heavy long chain hydrocarbon (paraffin) wax which can then be hydroconverted and fractionated to produce liquid transport fuels such as gas oils useable in diesel fuel compositions. Base oils, including heavy base oils, may also be produced by such a process.

By virtue of the Fischer-Tropsch process, a Fischer-Tropsch derived base oil has essentially no, or undetectable levels of, sulphur and nitrogen, e.g. below 5 ppm. Compounds containing these heteroatoms tend to act as poisons for Fischer-Tropsch catalysts and are therefore removed from the synthesis gas feed. This can bring additional benefits to lubricant compositions in accordance with the present invention. Further, the Fischer-Tropsch process as usually operated produces no or virtually no aromatic components. The aromatics content of a Fischer-Tropsch derived base oil component, suitably determined by ASTM D-4629, will typically be below 1 wt %, preferably below 0.5 wt % and more preferably below 0.1 wt % on a molecular (as opposed to atomic) basis.

Generally speaking, Fischer-Tropsch derived hydrocarbon products have relatively low levels of polar components, in particular polar surfactants, for instance compared to petroleum derived hydrocarbons. Such polar components may include for example oxygenates, and sulphur and nitrogen containing compounds. A low level of sulphur in a Fischer-Tropsch derived hydrocarbon is generally indicative of low levels of both oxygenates and nitrogen containing compounds, since all are removed by the same treatment processes.

In one embodiment, the Fischer-Tropsch derived base oil is defined by having a paraffin content of greater than 80 wt % paraffins, preferably greater than 85% wt or even greater than 90% wt paraffins, and a saturates content of greater than 99 wt % and comprising a series of iso-paraffins having n, n+1, n+2, n+3 and n+4 carbon atoms, wherein n is between 20 and 35. The presence of such a continuous series of iso-paraffins may be measured by Field desorption/Field Ionisation (FD/FI) technique. In this technique the oil sample is first separated into a polar (aromatic) phase and a non-polar (saturates) phase by making use of a high performance liquid chromatography (HPLC) method IP368/01, wherein as mobile phase pentane is used instead of hexane as the method states. The saturates and aromatic fractions are then analyzed using a Finnigan MAT90 mass spectrometer equipped with a Field desorption/Field Ionisation (FD/FI) interface, wherein FI (a “soft” ionisation technique) is used for the determination of hydrocarbon types in terms of carbon number and hydrogen deficiency. The type classification of compounds in mass spectrometry is determined by the characteristic ions formed and is normally classified by “z number”. This is given by the general formula for all hydrocarbon species: CₙH₂ₙ+z. Because the saturates phase is analysed separately from the aromatic phase it is possible to determine the content of the different iso-paraffins having the same stoichiometry or n-number. The results of the mass spectrometer are processed using commercial software (poly 32; available from Sierra Analytics LLC, 3453 Dragoo Park Drive, Modesto, Calif. GA95350 USA) to determine the relative proportions of each hydrocarbon type.

The Fischer-Tropsch derived base oil used in the invention may have preferably have a kinematic viscosity at 100° G according to ASTM D445 of at least 2 mm²/s, more preferably at least 4 mm²/s, most preferably at least 7 mm²/s. The kinematic viscosity of the Fischer-Trospch derived base oil at 100° C. may preferably be at most 50 mm²/s more preferably at most 35 mm²/s, most preferably at most 25 mm²/s.

Fischer-Tropsch derived base oil used in the invention is preferably obtained by (1) a Fischer-Tropsch synthesis step, (2) a hydrocracking/hydroisomerisation step on (part of) the Fischer-Tropsch synthesis product preferably followed by (3) a pour point reducing step of (a fraction of) the product of the hydroprocessing step. Either solvent or catalytic dewaxing may achieve reduction of pour point in step (3). The desired base oil having the desired viscosity can be isolated from said dewaxed product by means of distillation. Optionally the oil is hydrofinished or subjected to an adsorption treatment in order to improve its colour.

To obtain a Fischer-Tropsch derived oil, the Fischer-Tropsch synthesis step may for example be performed according to the so-called commercial Sasol process, the commercial Shell Middle Distillate Process or by the non-commercial Exxon process. These and other processes are described in more detail in EP-A-776959, EP-A-668342, U.S. Pat. No. 4,943,672, U.S. Pat. No. 5,059,299, WO-A-9934917 and WO-A-9920720. Most of these publications also describe the above-mentioned hydroisomerisation/hydrocracking step (2).

Suitable Fischer-Tropsch derived base oils that may be conveniently used as base oil in the lubricant composition of the present invention are those as for example disclosed in EP 0 776 959, EP 0 668 342, WO 97/21788, WO 00/15736, WO 00/14188, WO 00/14187, WO 00/14183, WO 00/14179, WO 00/08115, WO 99/41332, EP 1 029 029, WO 01/18156 and WO 01/57166.

To safeguard the purity of high pressure polyolefins, the base oil used in the invention may preferably be a Fischer-Trospch derived white oil complying with one or more relevant standards.

The white oil may be a technical white oil, and may preferably meet a relevant statutory standard e.g. as defined by FDA 21 CFR 178.3620 (b). The technical white oil may have a Saybolt colour of at least +20. UV absorbency limits per cm path length may be max 4.0 at 280-289 nm, max 3.3 at 290-299 nm, max 2.3 at 300-329 nm, max 0.8 at 330-350 nm.

To facilitate use of high pressure polyolefin products in food applications, it is preferred that the base oil be a Fischer-Tropsch derived medicinal white oil, e.g. compliant with one or more of EU Directive 2002/72/EEC for plastic materials and articles intended to come into contact with foodstuffs, European Pharmacopeia 5^{th} Edition, US Pharmacopeia 25^{th} edition/NF20, FDA 21 CFR 172.878, FDA 21 CFR 178.3620(a), and FDA 21 CFR 178.3570 (USDA H-1).

Preferably, medicinal white oil should contain not more than 5% (w/w) mineral hydrocarbons with carbon numbers less than 25, and have a kinematic viscosity at 100° C. according to ASTM D445 of at least 7 mm²/s or even 8.5 mm²/s and an average molecular weight of at least 480 g/mol.

In one embodiment, the Fischer-Tropsch derived white oil may have a Saybolt colour of greater than +25 and preferably equal to +30. The content of polar compounds is preferably less than 1 wt % and the content of noncyclic isoparaffins is preferably between 75 and 98 wt %. The ultra violet (UV) adsorption spectra values as measured according to ASTM D 2269 are preferably less than 0.70 in the 280-289 nm spectral band, less than 0.60 in the 290-299 nm spectral band, less than 0.40 in the 300-329 nm spectral band and less than 0.09 in the 330-380 nm spectral band as according to FDA 178.3620(c). The pour point of the oil is preferably below −10° C. and more preferably below −15° C. The CN number as measured according to IEC 590 is preferably be less than 30, more preferably between 15 and 30.

Suitable Fischer-Tropsch derived white oils may, for example, be produced according to the process of WO 02070627 A2, which permits the preparation of base oils having a kinematic viscosity at 100° C. of between about 2 and up to 30 cSt suitable for process oil applications or as medicinal white oil.

A further example of a Fischer-Tropsch derived medicinal white oil is described in WO2009018087.

In order to improve the colour properties of white oil fractions obtained for example from WO 02070627 A2 a final finishing treatment may be performed. Examples of suitable finishing treatments are so-called sulfuric acid treating processes, hydrofinishing or hydrogenation processes and adsorption processes. Sulfuric acid treating is for example described in General Textbook “Lubricant Base Oil and Wax Processing”, Avilino Sequeira, Jr, Marcel Dekker Inc., New York, 1994, Chapter 6, pages 226-227.

Hydrofinishing is suitably carried out at a temperature between 180 and 380° C., a total pressure of between 10 to 250 bar and preferably above 100 bar and more preferably between 120 and 250 bar. The WHSV (Weight hourly space velocity) ranges from 0.3 to 2 kg of oil per litre of catalyst per hour (kg/l·h).

The hydrogenation catalyst is suitably a supported catalyst comprising a dispersed Group VIII metal. Possible Group VIII metals are cobalt, nickel, palladium and platinum. Cobalt and nickel containing catalysts may also comprise a Group VIB metal, suitably molybdenum and tungsten. Suitable carrier or support materials are low acidity amorphous refractory oxides. Examples of suitable amorphous refractory oxides include inorganic oxides, such as alumina, silica, titania, zirconia, boric, silica-alumina, fluorided alumina, fluorided silica-alumina and mixtures of two or more of these.

Examples of suitable hydrogenation catalysts are nickel-molybdenum containing catalyst such as KF-847 and KF-8010 (AKZO Nobel) M-8-24 and M-8-25 (BASF), and C-424, DN-190, HDS-3 and HDS-4 (Criterion); nickel-tungsten containing catalysts such as NI-4342 and NI-4352 (Engelhard) and C-454 (Criterion); cobalt-molybdenum containing catalysts such as KF-330 (AKZO-Nobel), HDS-22 (Criterion) and HPC-601. (Engelhard). Preferably platinum containing and more preferably platinum and palladium containing catalysts are used. Preferred supports for these palladium and/or platinum containing catalysts are amorphous silica-alumina. Examples of suitable silica-alumina carriers are disclosed in WO-A-9410263. A preferred catalyst comprises an alloy of palladium and platinum preferably supported on an amorphous silica-alumina carrier of which the commercially available catalyst C-624 of Criterion Catalyst Company (Houston, Tex.) is an example.

The white oil as obtained by the process as described above, including the optional hydrogenation step, may also be contacted with an adsorbent to further increase the colour properties. Examples of suitable heterogeneous adsorbents are active carbon, zeolites, for example natural faujasite, or synthetic materials such as ferrierite, ZSM-5, faujasite, mordenite, metal oxides such as silica powder, silica gel, aluminum oxyde and various clays, for example Attapulgus clay (hydrous magnesium-aluminium silicate), Porocel clay (hydrated aluminium oxide). A preferred adsorbent is activated carbon.

The Fischer-Tropsch derived base oil may be present in the lubricant composition herein at a level of at least 50%, preferably at least 60%, more preferably at least 70%, by weight of the lubricant composition. The Fischer-Tropsch derived base oil is preferably present in the lubricant composition herein at a level of at most 95%, more preferably at most 90% and even more preferably at most 85% or even at most 80%, by weight of the lubricant composition.

Advantageously, all base oil in the lubricant composition herein may be Fischer-Tropsch derived. However, in addition to the Fischer-Tropsch derived base oil, the lubricant composition herein may also comprise a non-Fischer-Tropsch derived base oil, such as a conventional mineral base oil, for example a mineral white oil, preferably a technical or medicinal white oil meeting one or more of the standards mentioned above.

A second essential component in the lubricant composition herein is a polymeric thickener. The term “polymeric thickener” as used herein is intended to include polymers or oligomers suitable for increasing the viscosity of a Fischer-Tropsch base oil.

The terms “polymer” and “polymeric” are used herein to encompass “oligomer” and “oligomeric” where context permits.

Polymeric thickeners are also commonly referred to as viscosity modifiers and viscosity index improvers, although for the purpose of the present invention an improvement in viscosity index is not essential. A number of polymeric thickeners are known in the art and the polymeric thickener herein may contain a mixture of one or more such polymers.

Known polymeric thickeners include the group of polyalkyl(meth)acrylates, though they typically suffer from the disadvantage of low shear stability. Polyalkyl(meth)-acrylates may have a number average molecular weight of from 10,000 to 250,000, for example, 20,000 to 200,000. The polyalkyl(meth)acrylates may be prepared by conventional methods of free-radical or anionic polymerization.

The polymeric thickener herein may preferably be an olefin polymer, i.e. a homopolymer, copolymer, or terpolymer resulting from the polymerization of olefins, preferably C₂-C₁₀ olefins. The C₂-C₁₀ olefins include, for example, ethylene, propylene, 1-butene, isobutylene, 2-butene, isoprene, 1-octene, and 1-decease. Exemplary (co)polymers include polypropylene, polyisobutylene, ethylene/propylene copolymers, styrene/isoprene copolymers, styrene butadiene copolymers and 1-butene/isobutylene copolymers, and mixtures of the polymers thereof. The olefin polymer may preferably be aliphatic. Olefins for forming the olefin polymer may preferably have from 2 to about 6 carbon atoms per molecule and may preferably be selected from one or more of ethylene, propylene, butylene and isoprene.

The polymeric thickener herein typically comprises a polymer having a carbon backbone. Advantageously, the polymer may have a carbon backbone with alkyl branches having on average no more than three carbon atoms per branch. Branching may be determined based on the monomers used to form the polymer or according to the techniques described in “High Temperature GPC utilizing Function Specific Detectors” K Tribe, G Saunders, R Meissner, Macromol. Symp. 2006, 236, 228-23.

Preferably, the olefin polymer herein may conform to the following generic structure:

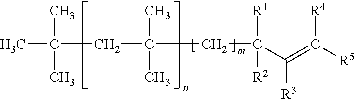

m=0 or 1
n=1−ca. 110

### R¹-R⁴=H or CH₃

### R5=H, CH₃, C₂H₅ or C₃H₇

Polybutene olefin polymers, especially homopolymers, formed from butylenes, especially isobutylene, are most preferred as the polymeric thickener herein. The above generic structure is typical of a polybutene olefin.

Polybutenes are commercially available from many manufacturers and are typically made via acid catalysed cationic polymerization of an isobutene-rich C4 stream.

Early polybutene products were made from a mixture of butenes including n-butenes and isobutene e.g. from a feedstock which is primarily butadiene raffinate or a crude C4 stream from a fluid catalytic cracking (FCC) process and contained from 20-40% n-butenes. The polymers produced in such processes were said to contain polybutene and polyisobutene in varying proportions, generally from 5-70% of polyisobuene and from 95-30% of poly-n-butenes.

Whilst such polybutenes are of use as polymeric thickeners herein, later processes have been developed for producing polybutene with a relatively low n-butene content, or substantially free therefrom. For the purpose of this invention, such polymers sold under the HYVIS® and NAPVIS® brands by BP chemicals and now commercially available for example under the INDOPOL® brand from Ineos Ltd, approximate to pure polyisobutene (PIB), even when having some n-butene incorporated, and are preferred herein.

One process for obtaining polybutenes useful as polymeric thickener herein is described in EP-A-0 145 235, in which a pre-formed boron trifluoride-ethanol complex is used as catalyst for the polymerisation of isobutene. This process results in a polymer which is not only low in n-butene content, or substantially free thereform, but also substantially free of chlorine.

In one embodiment, the proportion of n-butene in the polymer backbone, as defined by the ratio of the infra-red absorbance of the polymer at 740 cm⁻¹ to that at 4335 cm⁻¹, may be less than 0.5, most preferably less than 0.25. The definition for the proportion of n-butene in the polymer backbone has been defined by infra-red absorbance because this is a difficult concept to determine quantitatively. The technique for determining the proportion of n-butene is that described in EP 0640680 A1.

The number average molecular weight (Mₙ) of the olefin polymer, especially polybutene, used as the polymeric thickener herein may preferably be at least 300, for example at least 600 or 900, most preferably at least 1000. The number average molecular weight (Mₙ) of the olefin polymer, especially polybutene may preferably be at most 10,000, for example at most 6,000 or 2,500, most preferably at most 1,500. The number average molecular weights (Mₙ) are as determined by gel permeation chromatography, ASTM D3536 (mod) or ASTM D3592 (VPO).

The viscosity at 100° C. of the olefin polymer, especially polybutene, used as the polymeric thickener herein may preferably be at least 10 cSt, for example at least 50 cSt or more preferably 300 cSt, most preferably at least 500 cSt. The viscosity at 100° C. of the olefin polymer, especially polybutene, may preferably be at most 100,000 cSt, for example at most 50,000 cSt or 30,000 cSt or 6,000 cSt or 1,000 cSt or most preferably at most 800 cSt. The viscosities at 100° C. are as determined by the ASTM-D-445 standard.

The IUPAC number average degree of polymerisation (DPₙ) of the olefin polymer, especially polybutene, used as the polymeric thickener herein may preferably be at least 3, for example at least 10 or 15, most preferably at least 20. The IUPAC number average degree of polymerisation (DPₙ) of the olefin polymer, especially polybutene, may preferably be at most 2000 for example at most 500 or preferably 200, most preferably at most 35. The degree of polymerisation is defined as the number of monomeric units in a number average molecule.

The polymeric thickener may include a mixture of polymers and accordingly also extends to mixtures of several polymers, e.g. polybutenes, synthesized separately and possibly having molecular weights, viscosities or degrees of polymerisation outside the ranges of values indicated above, provided that the mixture of the various polybutenes has values lying within said ranges.

The poly(iso)butene herein is typically a viscous liquid miscible with the base oil. As indicated above, it may have a number-average molecular weight (Mn) for example in the range of from 600 to 10,000, or preferably from 1000 to 1,500, and a kinematic viscosity at 100° C. for example from 50 to 50 000 cSt, or preferably from 300 to 800 cSt.

The polymeric thickener may be present in the lubricant composition herein at a level of at least 5%, preferably at least 10%, more preferably at least 15% or even at least 20%, by weight of the lubricant composition. The polymeric thickener is preferably present in the lubricant composition herein at a level of at most 50%, more preferably at most 40% and even more preferably at most 30%, by weight of the lubricant composition.

Preferably, the lubricant composition according to the present invention comprises a Fischer-Tropsch derived base oil and a polymeric thickener, wherein the amount of thickener is 18 wt. % based on the total weight of the lubricant composition and the kinematic viscosity of the Fischer-Tropsch derived base oil at 100° C. according to ASTM D445 is at most 10 cSt.

Suitably, the lubricant composition according to the present invention comprises a mineral base oil and a polymeric thickener, wherein the amount of the thickener is 18 wt. % based on the total weight of the lubricant composition and the kinematic viscosity of the mineral base oil is at 100° C. according to ASTM D445 at most 12 cSt.

Also the lubricant composition according to the present invention comprises a Fischer-Tropsch derived base oil and a polymeric thickener, wherein the amount of thickener is 25 wt. % based on the total weight of the lubricant composition and the kinematic viscosity of the Fischer-Tropsch derived base oil at 100° C. according to ASTM D445 is at least 13 cSt.

Suitably, the lubricant composition according to the present invention comprises a mineral base oil and a polymeric thickener, wherein the amount of the thickener is 25 wt. % based on the total weight of the lubricant composition and the kinematic viscosity of the mineral base oil is at 100° C. according to ASTM D445 at least 16 cSt.

The lubricant composition of the invention may comprise conventional additives consistent with achieving desired properties for a high pressure compressor application.

For example, the composition may comprise one or more antioxidants. Preferred examples include food grade, oil-soluble, sterically hindered phenols and thiophenols, e.g., sterically hindered phenolics such as hindered phenols and bis-phenols, hindered 4,4′-thiobisphenols, hindered 4-hydroxy- and 4-thiolbenzoic acid esters and dithio esters, and hindered bis(4-hydroxy- and 4-thiolbenzoic acid and dithio acid) alkylene esters. In one embodiment, the antioxidant is selected from the group of food grade, oil-soluble aromatic amine antioxidants are naphthyl phenyl amines, alkylated phenyl naphthyl amines, and alkylated diphenyl amines. In one embodiment, the composition comprises phenolic and aromatic amine antioxidants in a ratio by weight ranging from 20:1 to 1:20. If present, an antioxidant may preferably be present in an amount up to 0.5%, more preferably up to 0.1% by weight.

In one embodiment, the composition comprises at least an anti-rust additive package having a combination of food grade ionic and non-ionic surface active anti-rust ingredients in an amount of 0.05 to 2.0 wt. %. Examples of ionic anti-rust lubricating additives include food grade phosphoric acid, mono and dihexyl ester compounds with tetramethyl nonyl amines, and mixtures thereof. Examples of non-ionic anti-rust lubricating additives include food grade fatty acids and their esters formed from the addition of sorbitan, glycerol, or other polyhydric alcohols, or polyalkylene glycols. Other non-ionic anti-rust lubricating additives can include food grade ethers from fatty alcohols alkoxylated with alkylene oxides, or sorbitan alkoxylated with alkylene oxides, or sorbitan esters alkoxylated with alkylene oxides.

In one embodiment, the composition comprises at least an anti-wear additive. Examples include but are not limited to food grade oil-soluble sulfur and/or phosphorus containing compounds such as a triphenylphosphorothioate. Other sulfur and/or phosphorus containing materials which are not currently approved for food grade use include: zinc dialkyl dithiophosphate, zinc dithiocarbamate, amine dithiocarbamate, and methylene bis dithiocarbamate.

In one embodiment, the composition further comprises a suitable nontoxic emulsifier. Examples include polyoxypropylene 15 stearyl ether (CFTA name: PPG-15 Stearyl Ether); ARLAMOL E Emollient-Solvent, available from ICI Surfactants; U. S. P./N. F. Grade emulsifying agents such as Acacia (CAS#9000-01-5); 2-Aminoethanol (CAS#141-43-5); Cholesterol (CAS#57-88-5); Octadecanoic Acid (CAS#57-11-4); lecithin; 9-Octadecanoic Acid (CAS#1 12-80-1); Polyethylene-Polypropylene Glycol (CAS#9003-11-6); Polyoxyl 20Cetostearyl Ester (CAS#9005-00-9); Polyoxyl 40 Stearyl (CAS#9004-99-3); Polysorbate 20 (CAS#9005-64-5); Polysorbate 40 (CAS#9005-66-7); Polysorbate 60 (CAS#9005-67-8); Polysorbate 80 (CAS#9005-65-8); Sodium Lauryl Sulfate (CAS#151-21-3); Sodium Stearate (CAS#882-162); Sorbitan Monooleate (CAS#1338-43-8); Sorbitan Monopalmitate (CAS#26266-57-9); Sorbitan Monostearate (CAS#1338-41-6); Triethanolamine (CAS#102-71-6).

The lubricant composition herein may typically be prepared by simple mixing of its components, preferably at a temperature of at least 50° C., preferably at least 70° C. e.g. at least 80° C. The mixing temperature, duration and conditions may be chosen by the skilled person as appropriate, to achieve homogeneous dissolution of the polymeric thickener or obtain a clear and bright composition. In one embodiment, the composition is prepared by heating the base oil to a temperature of at least 80° C., adding the polymeric thickener to the base oil, and stirring for at least one hour, preferably two hours to achieve homogeneous dissolution.

According to aspects of the invention, the lubricant composition herein is used to lubricate a high pressure compressor. Use of the lubricant composition in a hyper compressor is particularly beneficial and preferred throughout. Hyper compressors deliver operating pressures of at least 50 MPa, preferably 100 MPa or even 150 MPa and hence require lubricants particularly resistant to dissolution of compressed raw material, such as those of the invention. The term “high pressure compressor” wherever used herein hence also implies the preferred “hyper compressor”.

A high pressure compressor herein may be of the horizontal balanced opposed reciprocating type. The compressor, especially hyper compressor, may be of the positive displacement, reciprocating crosshead, multi-stage type. It may comprise one or more packed-plunger type cylinders, preferably made from sold tungsten-carbide or tungsten-carbide coated steel. Such compressors are supplied, for example by Burckhardt Compression AG and Nuovo Pignone (GE Energy).

According to aspects of the invention, the lubricant composition is used to lubricate a friction interface of the compressor, typically between a moving part and a non-moving part or two moving parts of the compressor. Depending on application, the lubricant composition may be used for one or more of crankcase lubrication, cross-head-lubrication, cylinder lubrication, cooling and flushing. The lubricant composition herein is of particular use in cylinder lubrication, which may encompass lubricating, or applying the lubricant composition herein to, one or more of cylinder walls, piston rings, valves, rod pressure packing and gas seals of a high pressure compressor.

To deliver the lubricant composition to the moving parts, it is typically pumped through one or more channels. Cylinders, for example, may be lubricated by force-fed lubrication. The lower viscosity of the lubricant composition at a given polymeric thickener content is of particular benefit in this regard since it facilitates pumping and force-feeding, reducing demands on pumping equipment and energy.

According to aspects of the invention, use of the lubricant composition herein in a hyper compressor may encompass supplying the lubricant composition in a set including instructions to apply the lubricant composition to a high pressure compressor. The instructions may simply take the form of a label designating the composition as a high pressure compressor lubricant composition or a hyper compressor lubricant composition. They may for example be provided on a container holding the lubricant composition or in an accompanying leaflet or documentation. Typically, the instructions in this high pressure compressor lubricating set may include advice on how to use and apply the lubricant according to the present invention, also indicating at which conditions, such as pressure, preheating and minimum flow the lubricant may be used.

High pressure compressors may in principle be used to compress any gaseous raw material, typically of low molecular weight (e.g. below 60, 40 or even 20). The raw material is typically carbonaceous, i.e. contains one or more carbon atoms. Particularly common raw materials are olefins, especially ethylene, which is used in the manufacture of high pressure low density polyethylene (HP-LDP) or ethylene vinyl acetate.

The lubricant composition herein may be used, according to aspects of the invention, in a method of pressurising or compressing an olefin, the method comprising: introducing an olefin into a high pressure compressor that is lubricated by the lubricant composition herein; and pressurising the olefin with the high pressure compressor. In a preferred embodiment, the olefin is ethylene. The olefin may be pressurised to a pressure of at least 25 MPa, preferably at least 50 MPa, most preferably at least 100 MPa or even 200 Mpa.

According to aspects of the invention, the lubricant composition is used in a method of making a high pressure polyolefin, the method comprising: pressurising an olefin with a high pressure compressor that is lubricated by the lubricant composition herein; and reacting the pressurised olefin to form the high pressure polyolefin. The olefin may preferably be ethylene and the high pressure polyolefin may be HP-LDPE. Processes and catalysts for the production of high pressure olefins are known in the art. An example is the LyondellBasell Lupotech T® process based on a high pressure tubular reactor. Alternative processes employ high pressure autocleave reactors. The present invention is not limited with regard to the precise nature of the high pressure olefin process, although it is preferred that the olefin is pressurised by the high pressure compressor to a pressure of at least 25 MPa, preferably at least 50 MPa, most preferably at least 100 MPa or even 200 Mpa.

As aforesaid, the lubricant composition herein, on account of its enhanced proportion of polymeric thickener, displays improved properties relative to comparable mineral oil based compositions.

Given the particular benefits of the combination of a Fischer-Tropsch derived base oil and polymeric thickener in the context of high pressure compressor lubrication, aspects of the invention embrace the use of a Fischer-Tropsch derived oil as a base oil in a high pressure compressor lubricant composition that includes a polymeric thickener.

When used in a high pressure compressor, in addition to counteracting friction and wear, the lubricant composition acts as a seal between moving parts of the compressor, to prevent the escape of compressed raw material, such as ethylene. The enhanced proportion of polymeric thickener in the lubricant composition at a given viscosity is also of benefit in this context.

As will be apparent to a skilled person, in an extremely high pressure environment such as high pressure compressors, hydrocarbon base oils, being mineral or Fischer-Tropsch derived, are soluble in low molecular weight compressed carbonaceous raw material such as ethylene. This in turn means that, in high pressure compressor applications, especially hyper compressors, base oils dissolve in compressed raw material and are displaced from lubricated interfaces, leaving mainly (or only) the polymeric thickener to perform the tasks of lubrication and sealing. Polymeric thickener is less susceptible to dissolution in low molecular weight compressed material such as ethylene and thereby preserves the lubricating and sealing performance of the composition.

In a high pressure compressor environment, it is desirable for lubricant compositions to comprise the highest possible proportion of polymeric thickener, whilst retaining pumpability. As the Fischer-Tropsch derived base oil in the lubricant composition herein has been found to allow the incorporation of greater amounts of polymeric thickener at a given viscosity compared to mineral base oil, the invention meets the objective of providing improved resistance to dissolution, especially olefin dissolution, and good viscosity/pumpability. A greater proportion of the composition can perform lubricating functions under high pressure compressor conditions, without an increase in viscosity.

A Fischer-Tropsch derived oil may hence advantageously be used as a base oil in a lubricant composition that includes a polymeric thickener, for the purpose of achieving a higher thickener content by % weight in the composition than would be achieved at the same viscosity by comparable use of a comparable mineral oil, e.g. of the same viscosity. The viscosity may for example be a kinematic viscosity at 40° C. or 100° C., at standard temperature and pressure.

Pumpability of the lubricant composition herein is a particularly important benefit. The Fischer-Tropsch based lubricant composition of the invention has been found to display reduced viscosity compared to a comparable mineral oil composition at a given proportion by weight of incorporated polymeric thickener. Such a reduced viscosity results in lower requisite pump pressure in delivering the composition to high pressure compressors. A Fischer-Tropsch derived oil may hence advantageously be used as a base oil in a lubricant composition that includes a polymeric thickener, for the purpose of achieving a lower viscosity in the composition than would be achieved by comparable use of a comparable mineral oil, e.g. of the same viscosity. The viscosity may for example be a kinematic viscosity at 40° C. or 100° C., at standard temperature and pressure.

Better pumpability (achieved by lower lubricant viscosity at a given polymeric thickener concentration) may give the advantage of either energy saving or the option to have a higher concentration of polymeric thickener in the lubricant formulation comprising Fischer-Tropsch derived base oil, and to bring this higher amount of polymeric thickener into the hypercompressor without increasing the viscosity if compared with a lubricant formulation comprising a mineral base oil/polymeric thickener combination.

The invention will now be further illustrated, by way of non-limiting example, with reference to the accompanying drawings in which:

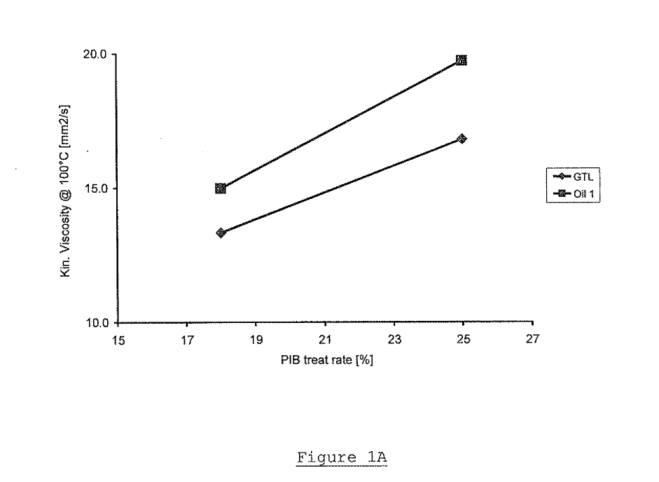

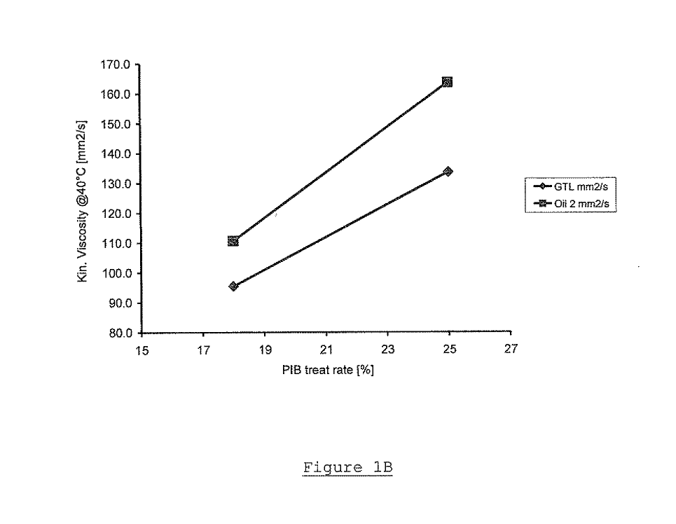

FIG. 1A shows the viscosity at 100° C. of exemplary lubricant composition blends based on a Fischer-Tropsch derived base oil (GTL 8) and a mineral base oil (Oil 2) respectively against polybutene content at 100° C.;

FIG. 1B shows the viscosity at 40° C. of exemplary lubricant composition blends based on a Fischer-Tropsch derived base oil (GTL 8) and a mineral base oil (Oil 1) respectively against polybutene content at 40° C.;

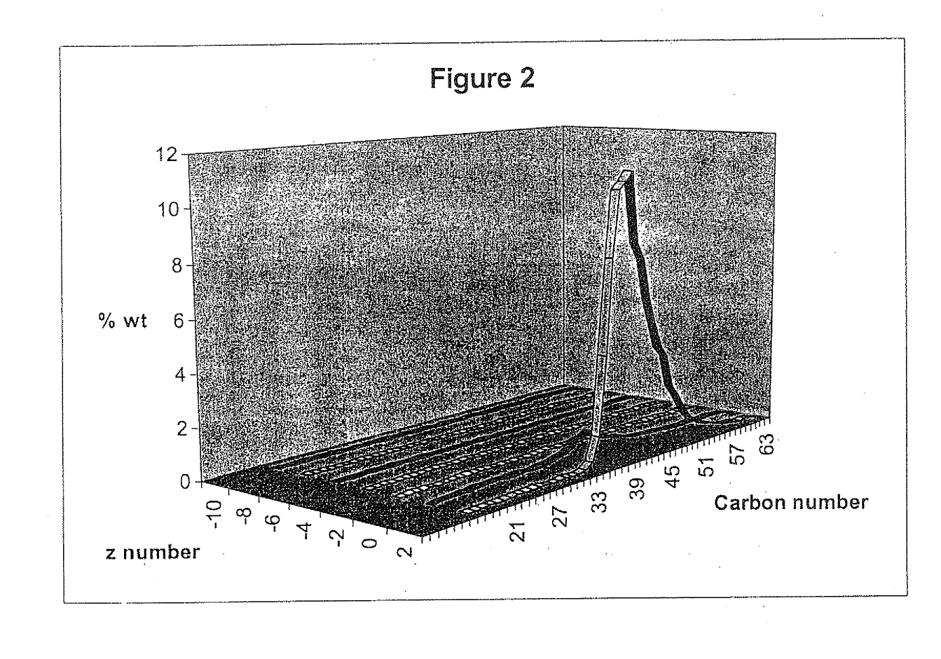

FIG. 2 shows the carbon distribution of Fischer-Tropsch derived base oil GTL 8.

### EXAMPLE 1

The thickening effect of HYVIS 30® polybutene, a polymeric thickener, on iso-viscous base oils derived from Fischer-Tropsch synthesis or mineral oil was evaluated.

HYVIS 30® is a product formerly available from BP Chemicals Limited. An equivalent product is available from Ineos Ltd under the brand INDOPOL H-300®.

The properties of HYVIS 30® approximate to polyisobutene, although it typically contains a small amount of n-butene. HYVIS 30® has a molecular weight of about 1300, which may be measured e.g. by ASTM D3592 (VPO) or ASTM D 3536 (GPC, modified). Other typical physical properties of HYVIS 30® are listed in Table 1.

TABLE 1

| Property | | Test Method | HYVIS 30 ® |
|---|---|---|---|
| Molecular weight | | ASTM D3592 | 1300 |
| Number Average | | (VPO) | |
| Viscosity | cSt | ASTM D445 | 635 |
| at 100° C. | SSU | ASTM D445 | 2960 |
| Flash | ° C. | ASTM D93 | 170 |
| point PMCC | | | |
| Flash | ° C. | ASTM D92 | 240 |
| point COC | | | |
| Pour point | ° C. | IP 15/86 | 4 |
| Density at | g/cm⁻³ | IP 190/86 | 0.902 |
| 15° C. | | | |
| Colour | Hazen | ASTM D1209 | 50 |
| Viscosity | | BS 4459 | 181 |
| index | | | |
| Refractive | | ASTM D1747 | 1.498 |
| index | | | |
| Bromine | g | IP 129/87 | 12 |
| number | Br²/100 g | | |
| Acid | mg KOH/g | ASTM D974 | 0.03 |
| number | | | |
| Water | Ppm | ASTM 1744 | 40 |
| content | | (Modified) | |
| Iron | Ppm | ASTM D2849 | <1 |

The mineral oil derived base oils subject to evaluation and comparison were:
“GTL 8”, a straight run Fischer-Tropsch derived base oil prepared by a Fischer-Tropsch synthesis, followed by hydrocracking, catalytic dewaxing and distillation. The carbon distribution of “GTL 8” is shown in FIG. 2. GTL 8 is a technical white oil.
“Oil 1” a mineral white oil blend iso-viscous with GTL 8 at 100° C. This oil was formed by pre-blending 82% by weight of Shell Ondina 937™ with 18% by weight of Shell Ondina 917™, which are both commercially available medicinal white oils.
“Oil 2” a mineral white oil iso-viscous with GtL 8 at 40° C. This oil was formed by by pre-blending 65% by weight of Shell Ondina 937™ with 35% by weight of Shell Ondina 917™, which are both commercially available medicinal white oils.
   The properties of the base oils are shown in Table 2.

TABLE 2

| Property | | ASTM | Oil 1 | Oil 2 | GTL 8 |
|---|---|---|---|---|---|
| Kinematic Viscosity | mm2 s−1 | D445 | 7.7 | 6.5 | 7.8 |
| (Vk) @ 100 oC | | | | | |
| Kinematic Viscosity | mm2 s−1 | D445 | 57.4 | 43.7 | 43.9 |
| (Vk) @ 40 oC | | | | | |
| Density @ 15 oC | kg m−3 | D4052 | 865.0 | 863.0 | 827.6 |
| Viscosity Index (VI) | | D2270 | 97 | 99 | 148 |
| Pour point | oC | D5950 | −12 | −12 | −24 |

“Oil 1”, “Oil 2” and “GTL 8”, were each combined with HYVIS 30® to produce formulations containing 18 wt % and 25 wt % HYVIS 30® (i.e. polybutene treat rates of 18% wt and 25% wt). In each case the base oil was heated to a temperature of 80° C. in a beaker, whereupon the relevant amount of HYVIS 30® was added. Stirring was carried out for two hours in each case and homogenous, clear and bright formulations were obtained.

The density, kinematic viscosity at 40° C. and 100° C., and viscosity index (VI) of each formulation thus obtained were determined. The dynamic viscosity, the thickening, and the thickening power of the polybutene was calculated. The results are set out in Table 3.

TABLE 3

| | | | Base oil | | | | | |
|---|---|---|---|---|---|---|---|---|
| Property | | ASTM | GTL 8 | GTL 8 | Oil 1 | Oil 1 | Oil 2 | Oil 2 |
| Polybutene | % | | 18 | 25 | 18 | 25 | 18 | 25 |
| treat rate | | | | | | | | |
| Base oil | mm²s⁻¹ | | 43.9 | 43.9 | 57.4 | 57.4 | 43.7 | 43.7 |
| kinematic | | | | | | | | |
| viscosity @ | | | | | | | | |
| 40° C. | | | | | | | | |
| Base oil | mm²s⁻¹ | | 7.8 | 7.8 | 7.7 | 7.7 | 6.5 | 6.5 |
| kinematic | | | | | | | | |
| viscosity @ | | | | | | | | |
| 100° C. | | | | | | | | |
| Formulation | | | 1 | 2 | 3 | 4 | 5 | 6 |
| GTL 8 | E3871 | | 82 | 75 | | | | |
| Oil 1 | | | | | 82 | 75 | | |
| Oil 2 | | | | | | | 82 | 75 |
| Hyvis 30 ® | | | 18 | 25 | 18 | 25 | 18 | 25 |

Measured values

| | | | | | | | | |
|---|---|---|---|---|---|---|---|---|
| Density at | kgm⁻³ | D4052 | 840.2 | 845.2 | 871.5 | 874.2 | 869.6 | 872.2 |
| 15° C. | | | | | | | | |
| Kinematic | mm²s⁻¹ | D445 | 95.4 | 133.6 | 140.6 | 209.7 | 110.6 | 163.6 |
| viscosity @ | | | | | | | | |
| 40° C. | | | | | | | | |
| Kinematic | mm²s⁻¹ | D445 | 13.3 | 16.8 | 15.0 | 19.7 | 12.9 | 16.9 |
| viscosity @ | | | | | | | | |
| 100° C. | | | | | | | | |
| Viscosity | | D2270 | 139 | 136 | 107 | 108 | 111 | 111 |
| Index (VI) | | | | | | | | |

Thickening characteristics calculated from kinematic viscosities

| | | | | | | | |
|---|---|---|---|---|---|---|---|
| Thickening | Calc* | 117% | 204% | 145% | 265% | 153% | 274% |
| 40° C. | | | | | | | |
| Thickening | Calc* | 71% | 115% | 95% | 156% | 99% | 161% |
| 100° C. | | | | | | | |
| Thickening | Calc** | 6.52 | 8.17 | 8.05 | 10.61 | 8.50 | 10.97 |
| Power 40° C. | | | | | | | |
| Thickening | Calc** | 3.94 | 4.62 | 5.25 | 6.24 | 5.49 | 6.42 |
| Power 100° C. | | | | | | | |

Thickening characteristics calculated from dynamic viscosities

| | | | | | | | | |
|---|---|---|---|---|---|---|---|---|
| Dynamic | | Calc | 78.6 | 110.7 | 120.3 | 179.9 | 94.4 | 140.0 |
| viscosity @ | | | | | | | | |
| 40° C. | | | | | | | | |
| Dynamic | | Calc | 10.44 | 13.24 | 12.23 | 16.15 | 10.51 | 13.84 |
| viscosity @ | | | | | | | | |
| 100° C. | | | | | | | | |
| Density @ | kgm⁻³ | Calc | 823.5 | 828.45 | 855.3 | 858 | 853.1 | 856 |
| 40° C. | | | | | | | | |
| Density @ | kgm⁻³ | Calc | 783.3 | 788.25 | 816.3 | 819 | 813.5 | 817 |
| 100° C. | | | | | | | | |
| Thickening, | | Calc* | 79% | 152% | 110% | 213% | 116% | 220% |
| dynamic @ | | | | | | | | |
| 40° C. | | | | | | | | |
| Thickening, | | Calc* | 34% | 70% | 59% | 110% | 62% | 113% |
| dynamic @ | | | | | | | | |
| 100° C. | | | | | | | | |
| Thickening Power, | | Calc** | 4.39 | 6.08 | 6.08 | 8.54 | 6.44 | 8.82 |
| dynamic 40° C. | | | | | | | | |
| Thickening Power, | | Calc** | 1.88 | 2.79 | 3.27 | 4.39 | 3.43 | 4.52 |
| dynamic 100° C. | | | | | | | | |

*Thickening = (blend viscosity − base oil viscosity)/base oil viscosity
**Thickening power = Thickening %/polybutene treat rate %

Reference is made to FIG. 1B, which illustrates a comparison of the polybutene's (Hyvis 30®) effect on kinematic viscosity in formulations based on GTL 8 and Oil 1 at 40° C.

Reference is made to FIG. 1A, which illustrates a comparison of the polybutene's (Hyvis 30®) effect on kinematic viscosity in formulations based on GTL 8 and Oil 2 at 100° C.

A comparison of the kinematic viscosities of the formulations derived from the iso-viscous base oils (i.e. GTL 8 and Oil 1 at 40° C.; GTL 8 and Oil 2 at 100° C.) shows reduced thickening power of HYVIS 30® at both 18 and 25% polybutene treat rates in the Fischer-Tropsch derived base oil compared to mineral base oil. Expressed in another way, formulations based on Fischer-Tropsch derived base oil were less susceptible to thickening than mineral base oil formulations. Relevant comparisons are as follows:

GTL 8 and Oil 1 (18% polybutene treat rate, 100° C.):
Kinematic viscosity (mm² s⁻¹) (GTL 8): 13.3
Kinematic viscosity (mm² s⁻¹) (Oil 1): 15.0
Thickening power, kinematic (GTL 8): 3.94
Thickening power, kinematic (Oil 1): 5.25
   GTL 8 and Oil 1 (25% polybutene treat rate, 100° C.):
Kinematic viscosity (mm² s⁻¹) (GTL 8): 16.8
Kinematic viscosity (mm² s⁻¹) (Oil 1): 19.7
Thickening power, kinematic (GTL 8): 4.62
Thickening power, kinematic (Oil 1): 6.24
   GTL 8 and Oil 2 (18% polybutene treat rate, 40° C.):
Kinematic viscosity (mm² s⁻¹) (GTL 8): 95.4
Kinematic viscosity (mm² s⁻¹) (Oil 2): 110.6
Thickening power, kinematic (GTL 8): 6.52
Thickening power, kinematic (Oil 2): 8.50
   GTL 8 and Oil 2 (25% polybutene treat rate, 40° C.):
Kinematic viscosity (mm² s⁻¹) (GTL 8): 133.6
Kinematic viscosity (mm² s⁻¹) (Oil 2): 163.6
Thickening power, kinematic (GTL 8): 8.17
Thickening power, kinematic (Oil 2): 10.97

Conversely, the data suggest that it is possible to incorporate a greater % wt of polybutene into formulations comprising Fischer-Tropsch derived base oil at a given viscosity. In other words, to achieve a targeted viscosity, a higher polybutene treat rate is required for Fischer-Tropsch based formulations compared to mineral oil based formulations. With the term “treat rate” is meant concentration.

HYVIS 30® was found to slightly increase the Viscosity Index (VI) in mineral oil based formulations, whereas it was found to slightly depress the Viscosity Index (VI) in Fischer-Tropsch based formulations.

On account of their high paraffin content, compositions 1 and 2 are expected to outperform or match mineral base oil compositions in high pressure pumping tests, despite their enhanced polymeric thickener content.

It is concluded that compositions 1 and 2 are particularly suitable as high pressure compressor, especially hyper compressor lubricant compositions. Advantageous use of these compositions in a high pressure compressor, especially a hyper compressor is envisaged.

1. A lubricant composition comprising a Fischer-Tropsch derived base oil and a polymeric thickener for lubricating a high pressure compressor.

2. The lubricant composition according to claim 1 wherein the high pressure compressor is a hyper compressor.

3. The lubricant composition according to claim 1 wherein the polymeric thickener is a homopolymer, copolymer, or terpolymer resulting from the polymerization of C₂-C₁₀ olefins.

4. The lubricant composition according to claim 1, wherein the polymeric thickener is a homopolymer, copolymer, or terpolymer resulting from the polymerization of ethylene, propylene, butylene or isoprene.

5. The lubricant composition according to claim 1, wherein the polymeric thickener is a polybutene.

6. The lubricant composition according to claim 1, wherein the polymeric thickener has a number average molecular weight (Mₙ) of from 600 to 10,000.

7. The lubricant composition according to claim 1 wherein the Fischer-Tropsch derived base oil is a medicinal white oil.

8. The lubricant composition according to claim 1 wherein the Fischer-Tropsch derived base oil base oil has a viscosity in the range of from 7 cSt to 50 cSt.

9. The lubricant composition according to claim 1, wherein the composition comprises from 50 to 95% wt of the Fischer-Tropsch derived base oil and from 5% to 50% wt polymeric thickener.

10. (canceled)

11. The lubricant composition of claim 1, comprising, as polymeric thickener, from 5% to 50% wt of a homopolymer, copolymer, or terpolymer resulting from the polymerization of ethylene, propylene, butylene or isoprene, having a number average molecular weight (Mₙ) of from 600 to 10,000 and, as base oil, from 50% to 95% wt of a Fischer-Tropsch derived medicinal white oil.

12. The lubricant composition of claim 2 comprising from 15% to 50% wt polymeric thickener and from 50% to 85% wt Fischer-Tropsch derived base oil.

13. A high pressure compressor lubricating set comprising a lubricant composition according to claim 1 and instructions to apply the lubricant composition to a high pressure compressor.

14. A method of pressurising an olefin or making a high pressure polyolefin, the method comprising: introducing an olefin into a high pressure compressor that is lubricated by a lubricant composition according to claim 1; pressurising the olefin with the high pressure compressor; and optionally reacting the pressurised olefin to form a high pressure polyolefin.

15. A Fischer-Tropsch derived oil as a base oil in a high pressure compressor lubricant composition that includes a polymeric thickener, for the purpose of achieving:
a higher thickener content by % weight in the composition than would be achieved at the same viscosity by comparable use of a comparable mineral oil; and/or
a lower viscosity in the composition than would be achieved by comparable use of a comparable mineral oil.
